(19) United States
(12) Patent Application Publication
(10) Pub. No.: US 2013/0278601 A1
(43) Pub. Date: Oct. 24, 2013

(54) Method and Apparatus for Processing Texture Mapping in Computer Graphics by Biasing Level of Detail According to Image Content and Computer Readable Storage Medium Storing the Method

(71) Applicants: Wei-Chao Chen, Changhua City (TW); Chia-Ming Chang, New Taipei City (TW)

(72) Inventors: Wei-Chao Chen, Changhua City (TW); Chia-Ming Chang, New Taipei City (TW)

(73) Assignee: INSTITUTE FOR INFORMATION INDUSTRY, Taipei (TW)

(21) Appl. No.: 13/599,933

(22) Filed: Aug. 30, 2012

(30) Foreign Application Priority Data
Apr. 20, 2012 (TW) 101114213

(51) Int. Cl. G06T 15/04; G06T 15/80

(52) U.S. Cl. 345/426; 345/419

(57) ABSTRACT

A method for processing texture mapping by biasing level of detail (LOD) according to image content includes: a texture request for fetching a target texel is received. The texture request includes a target texture coordinate at a target LOD of a target texture mipmap corresponding to the target texel. A target level of content (LOC) bias map corresponding to the target texture mipmap is looked up according to the target texture coordinate and the target LOD to fetch a target LOC bias value corresponding to the target texture coordinate at the target LOD. A replacement LOD is calculated according to the target LOD and the target LOC bias value. A replacement texel is fetched at a corresponding coordinate, which corresponds to the target texture coordinate, at the replacement LOD of the target texture mipmap. Texture filtering is processed according to the replacement texel.

### RELATED APPLICATIONS

This application claims priority to Taiwan Application Serial Number 101114213, filed Apr. 20, 2012, which is herein incorporated by reference.

### BACKGROUND

1. Technical Field

The present invention relates to a method and apparatus for processing texture mapping in computer graphics by biasing level of detail (LOD) according to image content, and a computer readable storage medium with a computer program to execute the method.

2. Description of Related Art

Graphics Processing Units (GPU) are widely installed in several electrical apparatus, such as personal computers, work stations, game consoles, etc., for accelerating process of computer graphics.

Texture mapping is a method for adding details to 3D meshes, which can improve rendering quality without increasing computing complexity too much. Most GPUs utilize texture mapping for mapping a 2D image to a 3D meshes. However, —texturing requires a lot of transmission bandwidth.

Hence, in the prior arts, textures are often compressed for reducing transmission bandwidth. Since textures may be randomly accessed, texture compression is often performed with Block Truncation Coding, compression ratio of which can only achieve 6-8.

### SUMMARY

According to one embodiment of this invention, a method for processing texture mapping by biasing level of detail (LOD) according to image content is disclosed. The method may take the form of a computer program product stored on a computer-readable storage medium having computer-readable instructions embodied in the medium. The method includes the following steps:

(a) a texture request for fetching a target texel is received; the texture request includes a target texture coordinate at a target LOD of a target texture mipmap corresponding to the target texel.

(b) a target level of content (LOC) bias map corresponding to the target texture mipmap is looked up according to the target texture coordinate and the target LOD to fetch a target LOC bias value corresponding to the target texture coordinate at the target LOD.

(c) a replacement LOD is calculated according to the target LOD and the target LOC bias value.

(d) a replacement texel is fetched at a corresponding coordinate, which corresponds to the target texture coordinate, at the replacement LOD of the target texture mipmap.

(e) texture filtering is processed according to the replacement texel.

According to another embodiment of this invention, an apparatus for processing texture mapping by biasing LOD according to image content is disclosed. The apparatus includes a shader processor, a texture filter and a texture generator. The texture coordinate generator is electrically connected to the shader processor and the texture filter. The shader processor transmits a texture request for fetching a target texel. The texture request includes a target texture coordinate at a target LOD of a target texture mipmap corresponding to the target texel. The texture coordinate generator includes a look-up module, an LOD calculating module and a texel-fetching module. The look-up module looks up a target LOC bias map corresponding to the target texture mipmap according to the target texture coordinate and the target LOD to fetch a target LOC bias value corresponding to the target texture coordinate at the target LOD. The LOD calculating module calculates a replacement LOD according to the target LOD and the target LOC bias value. The texel-fetching module fetches a replacement texel at a corresponding coordinate, which corresponds to the target texture coordinate, at the replacement LOD of the target texture mipmap. The texture filter processes texture filtering according to the replacement texel.

The present invention can achieve many advantages. Since we can bias the LOD of a pixel in the texture to higher level of mipmap, that means the neighboring pixels in the texture are similar. We can use the lesser pixels of higher level of mipmap to approximate the original texels, which can reduce the required transmission bandwidth and power consumption for fetching the target texel.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for processing texture mapping by biasing level of detail (LOD) according to image content according to one embodiment of this invention;

FIG. 2 illustrates a scenario applying the method 100 for processing texture mapping; and

FIG. 3 illustrates a block diagram of an apparatus for processing texture mapping by biasing LOD according to image content according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

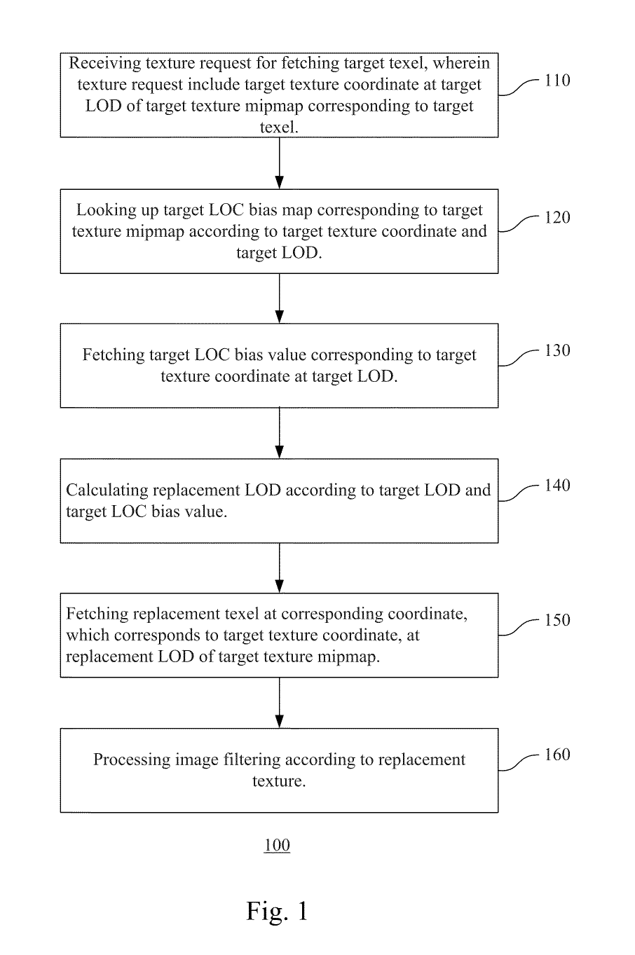

Referring to FIG. 1, a flow diagram will be described that illustrates a method for processing texture mapping by biasing level of detail (LOD) according to image content according to one embodiment of this invention. The method for processing texture mapping may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

The method 100 for processing texture mapping includes the following steps:

At step 110, a texture request for fetching a target texel is received. Wherein, the texture request includes a target texture coordinate at a target LOD of a target texture mipmap corresponding to the target texel. In one embodiment, when the target texel is required to being added to a 3D meshes, the information is calculated about the target texture coordinate at the target LOD of the target texture mipmap corresponding to the target texel. The target texture coordinate may be described as (u,v) or any other form utilizing any other coordinate space. The target texture mipmap may include texture images with different LODs. In some embodiments of this invention, each texture image at one LOD of the target texture mipmap is one-fourth the total area of the texture image at previous LOD. For example, if resolution of a texture image is 128×128, resolution of the texture image at previous LOD is 256×256

At step 120, a target level of content (LOC) bias map corresponding to the target texture mipmap is looked up according to the target texture coordinate and the target LOD to fetch a target LOC bias value corresponding to the target texture coordinate at the target LOD (step 130).

At step 140, a replacement LOD, resolution of a texture at which is lower than or the same as that of the original target LOD, is calculated according to the target LOD and the target LOC bias value.

At step 150, a replacement texel is fetched at a corresponding coordinate, which corresponds to the target texture coordinate, at the replacement LOD of the target texture mipmap.

At step 160, image filtering is processed according to the replacement texel. Hence, in one embodiment of this invention, the filtered replacement texel can be added to a 3D meshes by mapping.

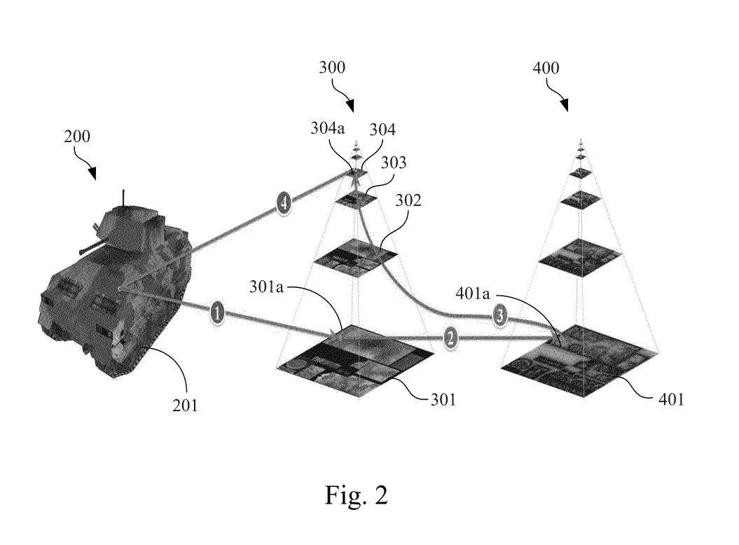

FIG. 2 illustrates a scenario applying the method 100 for processing texture mapping. Referring to FIG. 1 and FIG. 2, when a mapping for a block 201 of a 3D meshes is performed, a command to request for the mapping of the block 201 may be transmitted. The command may include the corresponding target texture mipmap 300, the target LOD 301 and the target texture coordinate 301a of the target texture mipmap 300, which the target texel is at. Accordingly, a texture request, which includes information about the target texture mipmap 300, the target LOD 301 and the target texture coordinate 301a, is generated for step 110.

Subsequently, the command is not performed for directly fetching the target texel, but a target LOC bias map 400 corresponding to the target texture mipmap 300 is looked up according to the target texture coordinate 301a and the target LOD 301 to fetch a target LOC bias value corresponding to the target texture coordinate at the target LOD (in other words, the value at corresponding coordinate 401a at corresponding level 401) at step 130.

In one embodiments, if the target LOC bias value is “3”, the replacement LOD 304 calculated at step 140 is “3” levels upper than the original target LOD 301.

Then, at step 150, a replacement texel is fetched at a corresponding coordinate 304a, which corresponds to the target texture coordinate 301a, at the replacement LOD 304 of the target texture mipmap 300.

Hence, at step 160, image filtering is processed according to the replacement texel, and the filtered replacement texel can be added to the block 201 of the 3D meshes 200.

In some embodiments of this invention, if a texture cache stores the required texture or the one corresponding to that, the texture can be fetched from the storage unit other than an external one. Hence, the method 100 for processing texture mapping may further include the following steps: determine if a texture cache stores the replacement texel or a corresponding texture at another LOD. Since resolution of the texture at lower LOD is higher than that at higher LOD, the corresponding texture at lower LOD can be taken as the replacement texel for mapping without quality affected. Accordingly, in one preferred embodiment of this invention, only the texture, LOD of which is lower than the replacement LOD of the replacement texel, can be taken as the corresponding texture. In one embodiment at step 150, when the texture cache stores the corresponding texture, the corresponding texture is fetched from the texture cache to be taken as the replacement texel for mapping. Therefore, the replacement texel can be fetched without accessing an external storage unit, which can reduce required transmission bandwidth, power consumption and delay.

In addition, when the texture cache does not store the replacement texel or the corresponding texture, the replacement texel may be fetched from an external storage unit other than the texture cache. When the texture cache stores the replacement texel, the replacement texel may be fetched from the texture cache, which can reduce the number for accessing an external storage unit.

In some embodiments of this invention, the target LOC bias map may be constructed in conjunction with wavelet transform. Let us denote the original image as I⁰ and the mipmaps as I={I⁰, I¹, I², . . . } where I^{k+1} is half the resolution of I^{k}. Given the mimaps, we can construct high-pass filtered images of I^{k}, namely:

$$\begin{matrix}{I}_{x}^{k + 1} ( x , y ) = \frac{1}{2} ( {I}^{k} ( 2 x + 1 , 2 y ) + {I}^{k} ( 2 x + 1 , 2 y + 1 ) ) - \frac{1}{2} ( {I}^{k} ( 2 x , 2 y ) + {I}^{k} ( 2 x , 2 y + 1 ) ) , & ( 1 ) \\ {I}_{y}^{k + 1} ( x , y ) = \frac{1}{2} ( {I}^{k} ( 2 x , 2 y + 1 ) + {I}^{k} ( 2 x + 1 , 2 y + 1 ) ) - \frac{1}{2} ( {I}^{k} ( 2 x , 2 y ) + {I}^{k} ( 2 x + 1 , 2 y ) ) , & ( 2 ) \\ {I}_{xy}^{k + 1} ( x , y ) = \frac{1}{2} ( {I}^{k} ( 2 x , 2 y ) + {I}^{k} ( 2 x + 1 , 2 y + 1 ) ) - \frac{1}{2} ( {I}^{k} ( 2 x + 1 , 2 y ) + {I}^{k} ( 2 x , 2 y + 1 ) ) , & ( 3 )\end{matrix}$$

where I^{k}(x, y) denotes the texture value of at LOD k and coordinate (x, y). These high-passed images contain the local details of the image. Together the set of images {Iₓ^{k},I_{y}^{k},I_{xy}^{k}|kε1, 2, 3, . . . } denotes the wavelet transform of the image I⁰. With the wavelet transform in place, it is possible to determine whether we can safely throw away data without significantly impacting the final reconstructed image. When the total energy is below a certain threshold, we replace its supporting texels {I^{k}(2x+dx,2y+dx)|dx,dyε{0,1}} with the texel I^{k+1}(x, y). In this case, we can safely increase the LOD level from k to k+1 at this texture coordinate. We store this information in a binary-valued LOC pyramid (or called target LOC bias map in this application), L_{b}={L_{b}⁰, L_{b}¹, L_{b}², . . . }, where L_{b}^{k}(x,y) is set to 1 when texel I^{k}(x, y) can be replaced by I^{k+1}(x/2,y/2). This provides a maximum of 4× bandwidth reduction plus one bit overhead per texel fetch.

To push this scheme even further, instead of using a binary LOC pyramid, we adopt for a LOC pyramid (the target LOC bias map) L={L⁰, L¹, L², . . . } that can cover the whole range of LOD values k={0, 1, 2, . . . }. The construction is as follows. For each texel in the pyramid (target texture mipmap), we look at its corresponding value in the target texture mipmap and greedily promote to the highest possible LOD level and record the level difference in L. Once the LOC pyramid (target LOC bias map) L is constructed, we can use it to fetch texels.

We store the LOC pyramid (target LOC bias map) L using exactly the same parameterization as the target texture mipmap to simplify the fetching process. Although storing the LOC maps as a pyramid may seem otherwise redundant, note that the LOC map value for the same texel may fluctuate both up and down. For example, for a high-frequency texture, its LOC map value may be zero at lower LOD and non-zero at higher LOD. For example, for a high-frequency texture, its LOC map value may be zero at lower LOD and non-zero at higher LOD once details of the texture have been smoothed out.

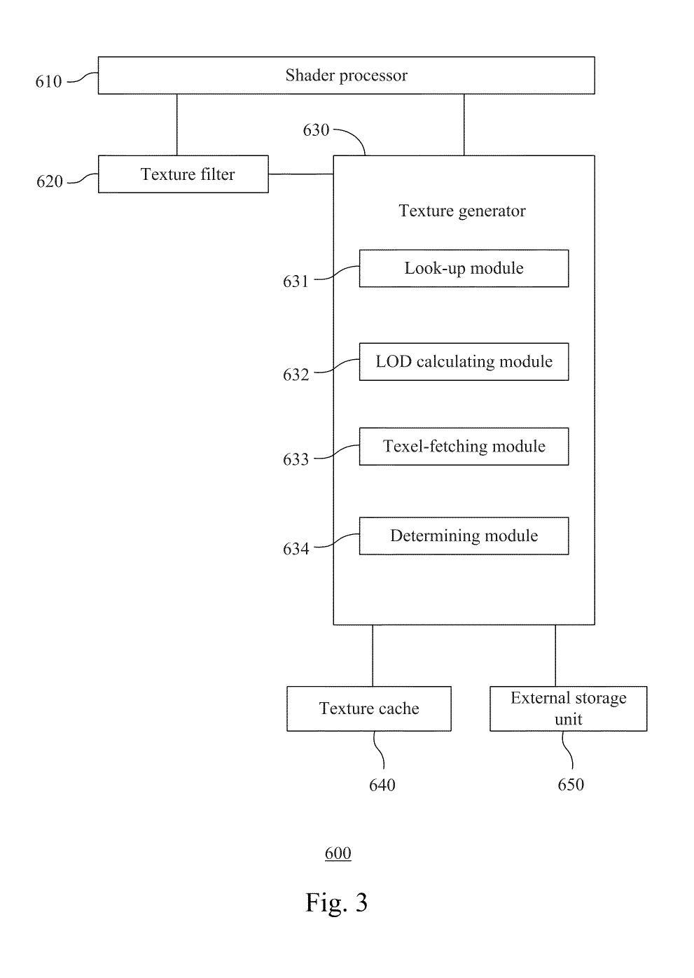

FIG. 3 illustrates a block diagram of an apparatus for processing texture mapping by biasing LOD according to image content according to an embodiment of this invention. The apparatus for processing texture mapping may be a Graphics Processing Unit (GPU) or any other apparatus for texture mapping.

The apparatus 600 for processing texture mapping includes a shader processor 610, a texture filter 620 and a texture generator 630. The texture generator 630 is electrically connected to the shader processor 610 and the texture filter 620. The shader processor 610 transmits a texture request for fetching a target texel. The texture request includes a target texture coordinate at a target LOD of a target texture mipmap corresponding to the target texel.

The texture generator 630 includes a look-up module 631, an LOD calculating module 632 and a texel-fetching module 633. The look-up module 631 looks up a target LOC bias map corresponding to the target texture mipmap according to the target texture coordinate and the target LOD to fetch a target LOC bias value corresponding to the target texture coordinate at the target LOD. The LOD calculating module 632 calculates a replacement LOD, The texel-fetching module 633 fetches a replacement texel at a corresponding coordinate, which corresponds to the target texture coordinate, at the replacement LOD of a target texture mipmap.

The texture filter 620 processes image filtering according to the replacement texel. Hence, in one embodiment of this invention, the shader processor 610 may add the filtered replacement texel to a 3D meshes. In addition, the apparatus 600 for processing texture mapping may further include a texture cache 640 electrically connected to the texture generator 630. A determining module 634 of the texture generator 630 may determine if the texture cache 640 stores the replacement texel or a corresponding texel, corresponding LOD of which is lower than the replacement LOD of the replacement texel. Since resolution of the texture at lower LOD is higher than that at higher LOD, the corresponding texture at lower LOD can be taken as the replacement texel for mapping without quality affected. Hence, in one preferred embodiment of this invention, the determining module 634 only take the texture, LOD of which is lower than the replacement LOD of the replacement texel, as the corresponding texture.

When the determining module 634 determines that the texture cache 640 stores the corresponding texture as mentioned above, the texel-fetching module 633 fetches the corresponding texture from the texture cache 640 to be taken as the replacement texel for mapping. When the texture cache 640 stores the replacement texel, the texel-fetching module 633 fetches the replacement texel from the texture cache 640. Therefore, required transmission bandwidth, power consumption and delay for mapping can be reduced.

Furthermore, the apparatus 600 for processing texture mapping may further include an external storage unit 650 electrically connected to the texture generator 630. The external storage unit 650 may indicates ROM, flash drives, HDD, databases access through networks or any other type of external storage unit. Hence, when the texture cache 640 does not store the replacement texel or the corresponding texture, the texel-fetching module 633 fetches the replacement texel from the external storage unit 650.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for processing texture mapping in computer graphics by biasing level of detail (LOD) according to image content, the method comprising:
(a) receiving a texture request for fetching a target texel, wherein the texture request comprises a target texture coordinate at a target LOD of a target texture mipmap corresponding to the target texel;
(b) looking up a target level of content (LOC) bias map corresponding to the target texture mipmap according to the target texture coordinate and the target LOD to fetch a target LOC bias value corresponding to the target texture coordinate at the target LOD;
(c) calculating a replacement LOD according to the target LOD and the target LOC bias value;
(d) fetching a replacement texel at a corresponding coordinate, which corresponds to the target texture coordinate, at the replacement LOD of the target texture mipmap; and
(e) processing image filtering according to the replacement texel.

2. The method for processing texture mapping of claim 1 further comprising:
determining if a texture cache stores the replacement texel or a corresponding texture, corresponding LOD of which is lower than the replacement LOD of the replacement texel,
wherein step (d) comprises:
when the texture cache stores the corresponding texture, fetching the corresponding texture from the texture cache to be taken as the replacement texel.

3. The method for processing texture mapping of claim 2, wherein step (d) further comprises:
when the texture cache does not store the replacement texel or the corresponding texture, fetching the replacement texel from an external storage unit other than the texture cache; and
when the texture cache stores the replacement texel, fetching the replacement texel from the texture cache.

4. The method for processing texture mapping of claim 1, further comprising:
constructing the target LOC bias map.

5. The method for processing texture mapping of claim 4, wherein the step of constructing the target LOC bias map comprising:
looking at corresponding values of texels in the target texture mipmap; and
greedily promoting to the highest possible LOD level of the corresponding values of the texels in the target texture mipmap and recording the level difference.

6. The method for processing texture mapping of claim 4, wherein the step of constructing the target LOC bias map comprising:
determining whether energy of each texel of the target texture mipmap is below a threshold, wherein when energy of a texel of the target texture mipmap is below the threshold, the LOD level of the texel whose energy below the threshold is increased.

7. An apparatus for processing three-dimensional texture mapping by biasing level of detail (LOD) according to image content, the apparatus comprising:
a shader processor which transmits a texture request for fetching a target texel, wherein the texture request comprises a target texture coordinate at a target LOD of a target texture mipmap corresponding to the target texel;
a texture filter; and
a texture generator electrically connected to the shader processor and the texture filter, wherein the texture generator comprises:
a look-up module which looks up a target LOC bias map corresponding to the target texture mipmap according to the target texture coordinate and the target LOD to fetch a target LOC bias value corresponding to the target texture coordinate at the target LOD;
an LOD calculating module which calculates a replacement LOD according to the target LOD and the target LOC bias value; and
a texel-fetching module which fetches a replacement texel at a corresponding coordinate, which corresponds to the target texture coordinate, at the replacement LOD of the target texture mipmap,
wherein the texture filter processes 3D image filtering according to the replacement texel.

8. The apparatus for processing texture mapping of claim 7 further comprising:
a texture cache electrically connected to the texture generator,
wherein the texture generator further comprises:
a determining module which determines if the texture cache stores the replacement texel or a corresponding texture, corresponding LOD of which is lower than the replacement LOD of the replacement texel,
wherein when the texture cache stores the corresponding texture, the texel-fetching module fetches the corresponding texture from the texture cache to be taken as the replacement texel,
wherein when the texture cache stores the replacement texel, the texel-fetching module fetches the replacement texel from the texture cache.

9. The apparatus for processing texture mapping of claim 8 further comprising:
an external storage unit electrically to the texture generator, wherein when the texture cache does not store the replacement texel or the corresponding texture, the texel-fetching module fetches the replacement texel from the external storage unit.

10. A computer readable storage medium with a computer program to execute a method for processing three-dimensional (3D) texture mapping by selecting level of detail (LOD) according to image content, wherein the method for processing texture mapping comprises:
(a) receiving a texture request for fetching a target texel, wherein the texture request comprises a target texture coordinate at a target LOD of a target texture mipmap corresponding to the target texel;
(b) looking up a target LOC bias map corresponding to the target texture mipmap according to the target texture coordinate and the target LOD to fetch a target LOC bias value corresponding to the target texture coordinate at the target LOD;
(c) calculating a replacement LOD according to the target LOD and the target LOC bias value;
(d) fetching a replacement texel at a corresponding coordinate, which corresponds to the target texture coordinate, at the replacement LOD of the target texture mipmap; and
(e) processing image filtering according to the replacement texel.
